(19) United States
(12) Patent Application Publication
(10) Pub. No.: US 2006/0251166 A1
(43) Pub. Date: Nov. 9, 2006

(54) DEVICE FOR RECEIVING ANALOGUE SIGNALS FOR DIGITAL TELEVISION AND CORRESPONDING RECEIVER

(76) Inventor: Julien Schmitt, Palaiseau (FR)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/279,324

(22) Filed: Apr. 11, 2006

(30) Foreign Application Priority Data
Apr. 11, 2005 (FR) 05 03573

(51) Int. Cl. H04N 11/04

(52) U.S. Cl. 375/240.01

(57) ABSTRACT

This device (2) for receiving a digital television signal (x(t)) corresponding to a real radio signal (s(t)), the device comprising an input for a real signal (I) and an input for a imaginary signal (Q), wherein the inputs (10) are connected to a correction stage (20) and a frequency conversion stage (30), the device (2) further comprising a control unit (42) for controlling the operation of the device (2) in accordance with the type of signal (x(t)) received in order to inhibit the correction stage (20) if the signal (x(t)) received is a real signal and in order to inhibit the conversion stage (30) if the signal (x(t)) received is a non-real complex signal.

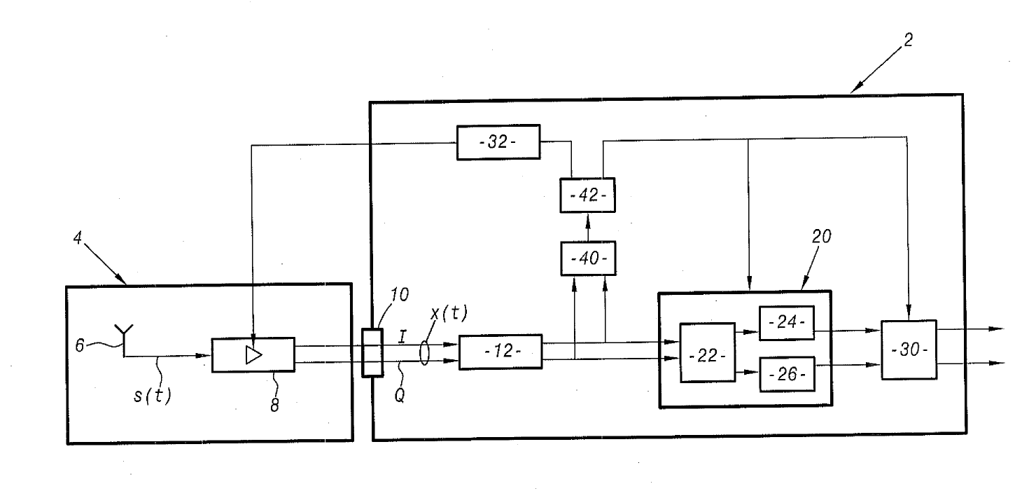

### TECHNICAL FIELD

The present invention relates to a device for receiving digital television signals and a corresponding receiver.

### BACKGROUND TO THE INVENTION

Digital television signals are either real signals which are referred to as being at intermediate frequency or non-real complex signals which are referred to as being at baseband and, in accordance with the nature of the signal, there are various receiving devices.

Generally, a real analogue radio signal is received then introduced into a tuner and an amplification stage before being converted into digital signals.

In a first instance, the signal transmitted by the tuner is a real signal which must be converted into baseband in order to form a complex signal which comprises a real portion and a imaginary portion forming a signal which can be demodulated.

In another case, the tuner directly transmits a signal in baseband, each of the real and imaginary components of which is introduced into a correction stage for correcting the phase, gain and continuous component in order to transmit a signal which can be demodulated.

Advantageously, in one or other case, an automatic gain control system, or AGC, is provided which allows the gain of the amplification stage of the radio signal to be controlled in accordance with the amplitude of the signal(s) after the analogue/digital conversion stage.

However, these two types of reception are not compatible, so that a specific device is provided for each particular type of signal; a first type is provided in order to be connected to a tuner which transmits real signals, and another type to a tuner which transmits non-real complex signals.

The object of the present invention is to overcome this problem by defining a device for receiving digital television signals which is suitable for being connected to the different existing types of tuner in order to receive both the real signals at intermediate frequency and the complex signals at baseband.

### SUMMARY OF THE INVENTION

To this end, the present invention relates to a device for receiving a digital television signal, corresponding to a real radio signal, the device comprising an input for a real signal and an input for a imaginary signal, wherein the inputs are connected to a correction stage and a frequency conversion stage, the device further comprising a control unit for controlling the operation of the device in accordance with the type of signal received, in order to inhibit the correction stage if the signal received is a real signal and in order to inhibit the conversion stage if the signal received is a non-real complex signal.

The device of the invention thus allows real signals and complex signals to be received and processed equally well.

According to other features of the invention:
the correction stage and conversion stage are connected in series to the inputs, each of the two stages being able to be inhibited whilst being controlled so as not to affect the signals which pass through it;
the correction stage and conversion stage are connected in parallel, and the device comprises a controllable commutator which allows the inputs to be connected to one or other of these two stages;
the device further comprises an automatic gain control generation unit for an amplifier of an item of equipment for receiving the radio signal, and the control unit is suitable for controlling the operation of the automatic control generation unit in accordance with the type of signal received;
the control unit is capable of providing, at the input, the automatic gain control generation unit with only the maximum strength signal from the signals received at these inputs;
the control unit is suitable for transmitting various predetermined values to the correction stage and conversion stage in accordance with the type of signal received;
the control unit is suitable for connecting the correction stage and conversion stage to various storage devices which contain the predetermined values, in accordance with the type of signal received;
the device further comprises an automatic determination unit for determining the type of signal received from a real signal and a non-real complex signal;
the device further comprises an analogue/digital conversion stage which is arranged between the inputs and the correction stage and conversion stage.

The present invention also relates to a digital television receiver of the type comprising a real radio signal receiver in order to transmit a digital television signal and a device for receiving a signal as described above.

The invention will be better understood from a reading of the following description, given purely by way of example and with reference to the appended drawing, which is a schematic drawing of a receiving device according to the invention.

### DESCRIPTION OF PREFERRED EMBODIMENTS

The FIGURE schematically illustrates a device 2 for receiving analogue signals for digital television according to the invention, also referred to in English as “Analog Front End Demodulator”.

This device 2 is connected to an item of equipment 4 for receiving a radio signal s(t) comprising an antenna 6 which is connected to a receiving and amplification stage 8 comprising, for example, a tuner and controllable amplification elements. Depending on the circumstances, this stage 8 transmits at the output either a real signal and a imaginary signal at baseband, or a real signal at intermediate frequency.

The device 2 first comprises a signal input 10 which allows a received signal x(t) to be received which corresponds to the radio signal s(t) and which is either a real signal at intermediate frequency, or a non-real complex signal at baseband. More precisely, the input 10 comprises an input for a real signal I and an input for a imaginary signal Q.

In this manner, when the stage 8 transmits only a real signal at intermediate frequency, only the terminal of the input 10 corresponding to the input terminal of a real signal is active.

Conversely, when the stage 8 transmits a signal at baseband, comprising a real component and a imaginary component, the two terminals of the input 10 are active.

In the embodiment described, the input 10 of the device 2 is connected to an analogue/digital conversion stage 12 which allows an analogue/digital conversion of the real signal I and imaginary signal Q to be carried out.

This conversion stage 12 is connected at the output to a correction stage 20 which comprises, in the embodiment described, a unit 22 for correcting gain and phase errors and units 24 and 26 for correcting continuous components of the real and imaginary signals, respectively.

Finally, the stage 20 is connected at the output to a frequency conversion stage 30 which transmits at the output a signal in baseband in the form of a signal which represents the real component and a signal which represents the imaginary component. The outputs of the stage 30 form the outputs of the device 2 and transmit a signal which can be demodulated.

Advantageously, the device comprises an automatic gain control generation unit 32 for the receiving and amplification stage 8, which unit is suitable for generating a signal which is intended to modify the gain of the amplification in order to optimise the conversion carried out in this stage 8. An automatic gain control of this type is carried out in a manner known per se.

Furthermore, the device comprises a automatic determination unit 40 for determining the type of signal x(t) received from a real signal and a non-real complex signal and a control unit 42 for controlling the operation of the device 2 in accordance with the determined type of the signal received.

In the embodiment described, the unit 40 is connected to the output of the conversion stage 12 and receives, at the input, the real portion I and imaginary portion Q of the signal (x)t received, converted into digital signals. Various tests are applied to these signals and in particular a test which allows the signal of maximum strength to be identified and a test which allows it to be determined whether one of these signals is zero or substantially zero. These tests serve to determine the type of signal (x)t received, in particular from a real signal and a complex signal. More precisely, if the imaginary signal Q is a signal which is substantially zero, the signal x(t) received is considered to be a real signal.

This information regarding the type of signal received is transmitted to the unit 42 which consequently controls various elements of the device 2 and in particular the correction stage 20, the conversion stage 30 and the automatic gain control 32.

The control unit 42 inhibits the correction stage 20 when the signal (x)t received is a real signal and, conversely, inhibits the conversion stage 30 when the signal x(t) received is a non-real complex signal.

Advantageously, the unit 42 inhibits a portion of the input 10 by connecting the input for the imaginary signal Q to earth when the signal x(t) received is a real signal in order to prevent disturbances at this input.

In the embodiment described, the unit 42 controls the correction stage 20 and conversion stage 30 by providing them with the values to be used in the course of the correction and conversion stages, these values being stored beforehand in peripheral storage devices which are not illustrated.

For example, the unit 42 commutates the switches which allow connection of each of the phase and gain error correction units 22, the continuous component correction stages 24 and 26 and the conversion stage 30, to different storage devices in order to transmit to them different predetermined values in accordance with the type of signal received.

In this manner, when the unit 40 determines that the signal x(t) received is a real signal, the units 22, 24 and 26 are commutated in order to receive at the input neutral correction values which do not affect the signal received whilst the frequency conversion stage 30 receives at the input values which correspond to the frequency conversion which allows the signal (x)t received to be converted into a baseband signal which can be demodulated.

Conversely, if the signal x(t) received is a complex signal, the unit 22 receives phase and gain error correction values which are determined in conventional manner and the units 24 and 26 receive at the input correction values for the continuous components.

In this instance, the conversion stage 30 receives at the input a unitary value so that no conversion is carried out and this stage 30 does not affect the signal which passes through it.

Furthermore, the unit 42 controls the automatic gain control unit 32 by providing it at the input with the maximum strength signal from the signals I and Q converted into digital signals. The automatic gain control of the stage 8 is thus carried out in accordance with the maximum strength signal in order to prevent phenomena of saturation during the amplification whilst allowing optimum amplification for a precise conversion.

For example, the unit 40 comprises a comparator which is interposed between the outputs of the conversion stage 12 and the automatic gain control unit 32 in order to transmit only the maximum strength signal from the output signals of the conversion stage 12.

Of course, other embodiments of the invention can be envisaged.

For example, the correction unit 20 and conversion unit 30 are connected in series but in the reverse order to that which has been set out above, so that the signal originating from the unit 12 is first introduced into the conversion unit, then the correction unit. In the same manner as above, the correction unit is inhibited if the signal is real and the conversion unit is inhibited if the signal is a non-real complex signal.

For example, the correction stage 20 and conversion stage 30 are arranged in parallel and the unit 42 controls a commutation between these stages in accordance with the type of signal received. Each of the stages 20 and 30 may or may not be connected following the previous stage. The outputs of the device are formed either by the outputs of the correction stage, or by the outputs of the conversion stage.

In a variant, the two connection and conversion stages are connected in parallel to the output of the previous stage and the unit 42 controls a commutation of the output in order to allow the outputs of the conversion stage or those of the correction stage to be transmitted.

In another embodiment, the receiving and amplification stage 8 is suitable for carrying out a different amplification on each path which allows the amplification on the path of the real signal and the path of the imaginary signal to be controlled separately and the automatic gain control is carried out separately on each path. Consequently, the gain control is carried out in the same manner, whatever the type of signal received.

In still another embodiment, the device is configured manually in order to be connected either to a tuner which transmits a real signal at intermediate frequency or to a tuner which transmits a signal at baseband. For example, a specific number of commutators or jumpers are arranged on an outer face of the device in order to be manually activated by a user so as to transmit to the control unit information relating to the type of signal.

Advantageously, use is made of software commutators by means of a programmable memory register, to which data is added before use, which informs the control unit as to whether the type of signal at the input is a real signal or a non-real complex signal.

1. Device for receiving a digital television signal corresponding to a real radio signal, the device comprising an input for a real signal and an input for a imaginary signal, wherein the inputs are connected to a correction stage and a frequency conversion stage, the device further comprising a control unit for controlling the operation of the device in accordance with the type of signal (x(t)) received, in order to inhibit the correction stage if the signal (x(t)) received is a real signal and in order to inhibit the conversion stage if the signal received is a non-real complex signal.

2. Device according to claim 1, wherein the correction stage and conversion stage are connected in series to the inputs, each of the two stages being able to be inhibited whilst being controlled so as not to affect the signals which pass through it.

3. Device according to claim 1, wherein the correction stage and conversion stage are connected in parallel, and the device comprises a controllable commutator which allows the inputs to be connected to one or other of these two stages.

4. Device according to claim 1, further comprising an automatic gain control generation unit for an amplifier of an item of equipment for receiving the radio signal, and wherein the control unit is suitable for controlling the operation of the automatic gain control generation unit in accordance with the type of signal received.

5. Device according to claim 4, wherein the control unit is capable of providing, at the input, the automatic gain control generation unit with only the maximum strength signal from the signals received at these inputs.

6. Device according to claim 1, wherein the control unit is suitable for transmitting various predetermined values to the correction stage and conversion stage in accordance with the type of signal (x(t)) received.

7. Device according to claim 6, wherein the control unit is suitable for connecting the correction stage and conversion stage to various storage devices which contain the predetermined values, in accordance with the type of signal received.

8. Device according to claim 1, further comprising an automatic determination unit for determining the type of signal received from a real signal and a non-real complex signal.

9. Device according to claim 1, further comprising an analogue/digital conversion stage which is arranged between the inputs and the correction stage and conversion stage.

10. Digital television receiver of the type comprising a real radio signal receiver in order to transmit a digital television signal and a device for receiving a signal of this type, according to claim 1.
